(19) United States
(12) Patent Application Publication
(10) Pub. No.: US 2023/0226971 A1
(43) Pub. Date: Jul. 20, 2023

(54) EXTERNAL LIGHTING EFFECTS FOR A VEHICLE

(71) Applicant: Panasonic Automotive Systems Company of America, Division of Panasonic Corporation of North America, Peachtree City, GA (US)

(72) Inventor: KARL WARREN FRISCH CRESSMAN, FARMINGTON HILLS, MI (US)

(21) Appl. No.: 18/104,044

(22) Filed: Jan. 31, 2023

Related U.S. Application Data
(60) Provisional application No. 63/299,781, filed on Jan. 14, 2022.

(51) Int. Cl. B60Q 1/54; F21S 43/50; B60Q 5/00

(52) U.S. Cl. CPC B60Q 1/54; F21S 43/50; B60Q 5/008

(57) ABSTRACT

Examples of the disclosure relate to example devices and methods for a lighting system for a non-internal-combustion-engine (non-ICE) powered vehicle. An example vehicle includes an electric motor for propelling the vehicle. The vehicle also includes an external light source disposed on the outside of the vehicle. The vehicle further includes a controller to monitor a performance parameter of the electric motor and control the external light source to generate a lighting effect that corresponds with the performance parameter of the electric motor.

### CROSS-REFERENCE TO RELATED APPLICATIONS

This application claims the benefit of U.S. Provisional Application No. 63/299,781, filed on Jan. 14, 2022, which the disclosure of which is hereby incorporated by reference in its entirety for all purposes.

### FIELD OF THE INVENTION

The present disclosure generally relates to a method, system, and device for generating external lighting effects in a vehicle.

### BACKGROUND

This section is intended to introduce the reader to various aspects of art, which may be related to various aspects of the present disclosure, which are described and/or claimed below. This discussion is believed to be helpful in providing the reader with background information to facilitate a better understanding of the various aspects of the present disclosure. Accordingly, it can be understood that these statements are to be read in this light, and not as admissions of prior art.

Land-based vehicles are beginning to transition away from traditional internal combustion engines (ICE) for their source of propulsion. It is anticipated that many of these vehicles will not generate substantive external noise. To achieve buyer acceptance of non-ICE vehicles such as battery-electric vehicles (BEVs), manufacturers are seeking to add vehicle-external sounds that are consistent with the vehicle brand's heritage. Accordingly, many non-ICE vehicles may be configured to generate a sound signature consistent with the former ICE's vehicle heritage.

### SUMMARY

The present disclosure generally relates to techniques for creating external lighting effects for non-ICE vehicles. An example vehicle in accordance with embodiments includes an electric motor for propelling the vehicle, an external light source disposed on the outside of the vehicle, and a controller to monitor a performance parameter of the electric motor and control the external light source to generate a lighting effect that corresponds with the performance parameter of the electric motor.

An example method in accordance with embodiments includes monitoring a performance parameter corresponding to input of a driver to an electric motor used for propulsion of the vehicle. The method also includes controlling an external light source disposed outside of the vehicle to generate a lighting effect that corresponds with the performance parameter of the electric motor.

An example lighting system in accordance with embodiments includes a light source configured to generate an external lighting effect. The lighting system also includes a controller to monitor a performance parameter of an electric motor and control the external light source to generate a lighting effect that corresponds with the performance parameter of the electric motor.

### BRIEF DESCRIPTION OF THE DRAWINGS

The above-mentioned and other features and advantages of the present disclosure, and the manner of attaining them, may become apparent and be better understood by reference to the following description of one example of the disclosure in conjunction with the accompanying drawings, where:

FIG. 1 is a block diagram of an example lighting system for non-ICE, in accordance with embodiments;

FIG. 2 is a perspective view of an non-ICE in accordance with embodiments;

FIGS. 3A and 3B are cross-sectional views of a mock tailpipe with a lighting source, in accordance with embodiments;

FIGS. 4A and 4B are cross-sectional views of another mock tailpipe with a lighting source, in accordance with embodiments; and

FIG. 5 is a process flow diagram summarizing an example method for operating a lighting system for a vehicle, in accordance with embodiments.

Correlating reference characters indicate correlating parts throughout the several views. The exemplifications set out herein illustrate examples of the disclosure, in one form, and such exemplifications are not to be construed as limiting in any manner the scope of the disclosure.

### DETAILED DESCRIPTION OF EXAMPLES

One or more specific examples of the present disclosure are described below. In an effort to provide a concise description of these examples, not all features of an actual implementation are described in the specification. It can be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it can be appreciated that such a development effort might be complex and time consuming, and is a routine undertaking of design, fabrication, and manufacture for those of ordinary skill having the benefit of this disclosure.

Vehicle illumination has been added to vehicles for a long time, for regulatory and cosmetic reasons. Automotive aftermarket solutions are generally passive, and only intended to enhance the vehicles' appearance. Such passive illumination solutions are not related to vehicle performance in any meaningful way.

The present disclosure describes techniques for pairing illumination effects with vehicle performance attributes. Performance attributes can include torque demand setting, vehicle acceleration/deceleration, and simulated transmission shifts. Such lighting effects may improve the customer acceptance of a non-ICE powertrain.

In some embodiments, external sound effects may also be generated that are intended to simulate the sound of an internal combustion engine, and the added illumination may be configured to be consistent with these external sound effects. For example, the external sound effects may be configured to simulate the exhaust noise generated by a high performance car. In internal combustion engine vehicles, an aggressive acceleration or a sudden off-throttle may result in a backfire sound as well as a flame caused by unburnt hydrocarbons as they exit the exhaust. To simulate such effects in a non-ICE, a sound may be generated to simulate the sound of a backfire, and a lighting effect may be generated to simulate the visual appearance of flames, thereby adding an additional dimension of realism to the backfire sounds.

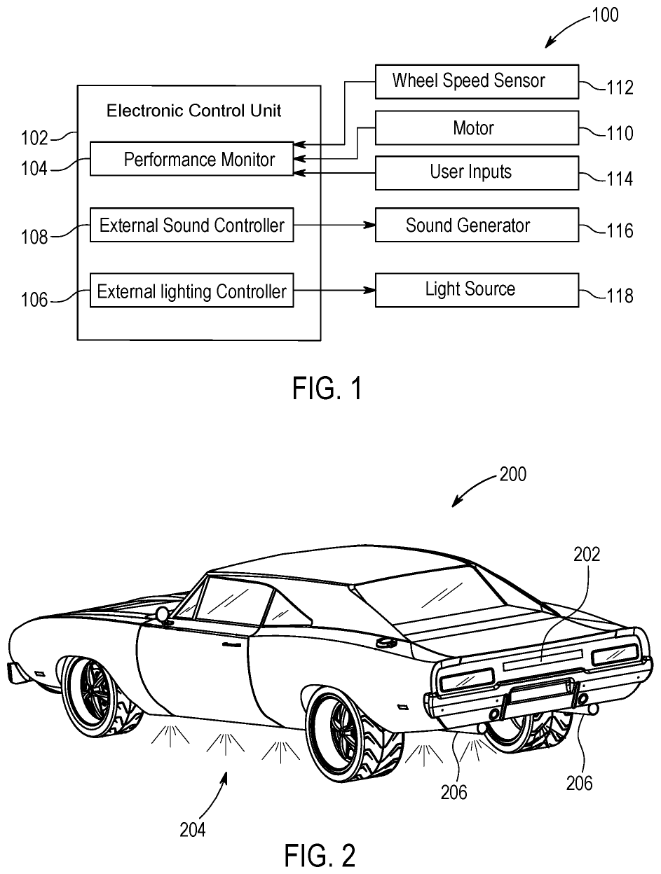

FIG. 1 is a block diagram of an example external lighting and sound system for a non-ICE vehicle in accordance with embodiments. The system 100 uses an electronic control unit 102 that is implemented in electronic hardware or a combination of hardware and computer code or embedded software. The electronic control unit 102 may include various modules and sensors configured for monitoring and/or controlling various vehicle subsystems. For example, the electronic control unit 102 may include a performance monitor 104, an external lighting controller 106, and an external sound controller 108. It will be appreciated that the vehicle and electronic control unit 102 will include various additional components and subsystems not described herein. The electronic control unit 102 may be coupled to the various vehicle subsystems through a controller area network (CAN).

The performance monitor 104 is configured to monitor one or more performance parameters related to performance of the vehicle or the vehicle's motor, such as the vehicle speed or acceleration, for example. As used herein, the term motor refers to the electric motor that propels the vehicle. The performance monitor 104 may receive input from sensors coupled to any one of a number of vehicle components, such as the motor 110, wheel speed sensors 112, user input devices 114 (e.g., torque demand foot pedal), and others. The performance parameters may include a torque demand setting, a rate of vehicle acceleration or deceleration, motor rotation rate, motor torque output, and others. The torque demand setting refers to the torque demand requested by the driver, and may be sensed by a torque demand sensor associated, for example, with a foot pedal.

The external sound controller 108 is communicatively coupled to the sound generator 116 and controls the sound generator 116 based on any one of the monitored performance parameters or a combination thereof. The sound generator 116 is an external sound generator, meaning that the sound is meant to be heard by people outside of the vehicle, as opposed to passengers within the vehicle. The external sound generator 116 may be one or more sound speakers, for example. The external sound generator 116 may be mounted to the vehicle in any suitable location, such as below the undercarriage, in an engine compartment, or others.

The external lighting controller 106 is communicatively coupled to the light source 118 and controls the light source 118 based on any one of the monitored performance parameters or a combination thereof. The light source 118 is an external light source, meaning that the light is meant to be seen by people outside of the vehicle, as opposed to passengers within the vehicle. The light source 118 may be one or more light emitting diodes (LEDs) or other types of lights, including incandescent, fluorescent, and others. The external light source 118 may be mounted to the vehicle in any suitable location, such as below the undercarriage, a rearward facing surface of the vehicle, or others.

The components shown in FIG. 1 may be implemented in hardware or a combination of hardware and programming software. For example, the performance monitor 104, an external lighting controller 106, and an external sound controller 108 may be implemented in logic circuitry, Application Specific Integrated Circuits (ASICs), microcontrollers, general-purpose processors processing instructions stored to a non-transitory memory device, and combinations thereof.

The system described in FIG. 1 can be used to implement a wide variety of lighting and/or sound effects related to the performance of the vehicle, such as the performance of the motor 110. If the performance parameter is a torque demand setting, the light source 118 may be controlled to generate an illumination intensity that is proportional to the torque demand setting. For example, the illumination intensity may be controlled to gradually increase as the torque demand indicated by the torque demand setting increases. If the performance parameter is a rate of vehicle acceleration or deceleration, the external light source 118 may be controlled to generate an illumination intensity that is proportional to the rate of vehicle acceleration or deceleration. For example, the illumination intensity may be controlled to gradually increase as the vehicle acceleration increases and decrease as the vehicle acceleration decreases. Other features of the light source 118 that may be controlled include color or a flashing interval. Additionally, if the light source 118 includes a number of light emitting elements, a pattern can be generated. For example, if the light source 118 is a light bar, generating a pattern may include controlling the length or width of the area of activated lighting elements in the light bar.

The sound generator 116 may also be controlled in a similar manner. If the performance parameter is a torque demand setting, the sound generator 116 may be controlled to increase the sound volume proportional to the torque demand indicated by the torque demand setting. For example, the sound volume may be controlled to gradually increase as the torque demand indicated by the torque demand setting increases. If the performance parameter is a rate of vehicle acceleration or deceleration, the sound generator 116 may be controlled to generate a sound volume that is proportional to the rate of vehicle acceleration or deceleration. For example, the sound volume may be controlled to gradually increase as the vehicle acceleration increases and decrease as the vehicle acceleration decreases. The generated sounds may be designed to simulate the sounds of a gasoline engine, and may change in volume, pitch, timbre, and other sound qualities based on the performance parameter.

In some embodiments, the external light source 118 and the external sound generator 116 are controlled to create a coordinated audio-visual effect such as a vehicle backfire or simulated transmission shifts. To simulate such a vehicle backfire, the sound generator 116 may be controlled to generate a popping or exploding sound, and the light source 118 may be controlled to simultaneously flash to simulate the visual appearance of a flame in the vehicle's tailpipe. The backfire effect may be initiated upon detecting, for example, a sudden increase or decrease in torque demand, as indicated by the torque demand setting. In various embodiments, a simulated transmission shift may be generated by generating a sound consistent with a transmission shift in an internal combustion engine vehicle. The light source 118 can also be adjusted in a coordinated manner, for example, by adjusting the illumination intensity to be proportional to a typical engine revolution rate that would be expected for the speed of the vehicle and the simulated gear.

The example implementations described above are only a small number of the possible implementations of the system described in FIG. 1. It will be appreciated that other features and processes can be enabled by the techniques described herein. Additionally, the block diagram of FIG. 1 is not intended to indicate that the system 100 is to include all of the components shown in FIG. 1. Rather, the system 100 can include fewer or additional components not illustrated in FIG. 1. Furthermore, the components may be coupled to one another according to any suitable system architecture.

FIG. 2 is a perspective view of a non-ICE vehicle 200 in accordance with embodiments. The non-ICE vehicle 200 shown in FIG. 2 can have any number or combination of external sound generators and/or light sources for implementing the techniques described herein. For example, one such external light source may be a light bar 202 disposed across the back of the vehicle. Another type of external light source could include one or more rows of lights (not shown) disposed below the undercarriage 204 of the vehicle 200 to project light onto the ground. In some embodiments, the vehicle 200 may have one or more pipes 206 disposed on the vehicle 200 to simulate a vehicle exhaust tailpipe. In such embodiments, the external light source and sound generator can be disposed within the pipes 206 for simulating a backfire effect.

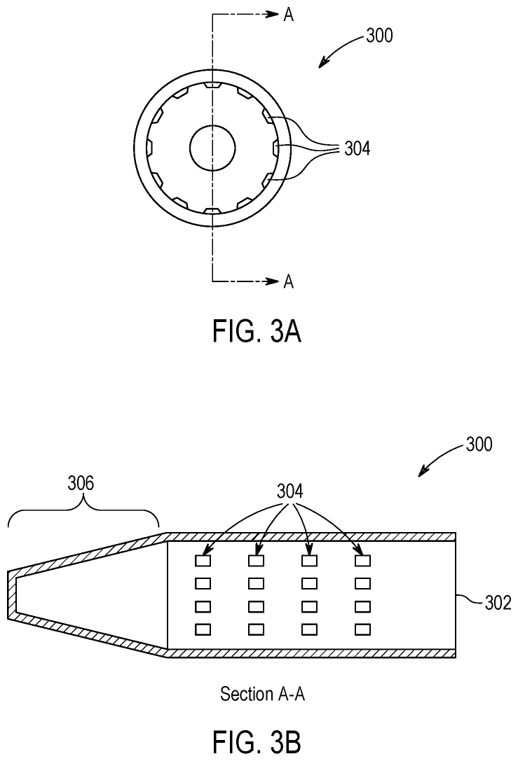

FIGS. 3A and 3B are cross-sectional views of a mock tailpipe with a lighting source in accordance with embodiments. The tailpipe 300 is configured to look like an actual exhaust pipe for a vehicle with an internal combustion engine. The tailpipe 300 has an open aperture 302 at one end, which is to be optically transparent to allow light to exit. In some embodiments, the open aperture 302 has a transparent covering to protect against the environment. The other end of the tailpipe, which is hidden from view when mounted on a vehicle, may be closed. In the embodiment shown in FIGS. 3A and 3B, the tailpipe is cylindrical. However, other embodiments may have any suitable shape.

The light source in this embodiment is an arrangement of several LEDs 304 disposed radially along the interior surface of the tailpipe. The LEDs 304 in FIGS. 3A and 3B are mounted in circular rows, and may be arranged with any suitable spacing. The number of LEDs 304 and their physical arrangement may be configured in other ways depending on the design of a particular implementation. Additionally, other types of lighting elements may be used in place of LEDs 304.

The interior surface of the tailpipe, or a portion thereof, may be reflective and may be smooth or textured. The closed end 306 of the tailpipe 300 may be shaped to better reflect the light from the LEDs 304 through the open end 302. For example, the closed end 306 can be cone shaped or partly cone shaped as shown in FIG. 3B.

To create a backfire effect, the LEDs 304 may be activated based on input from circuitry disposed in the vehicle, such as the vehicle's electronic control unit. The LEDs 304 may be activated simultaneously. However, in some embodiments, individual LEDs 304 or sets of LEDs 304 can be activated sequentially to create a chaotic lighting effect more reminiscent of exhaust flames.

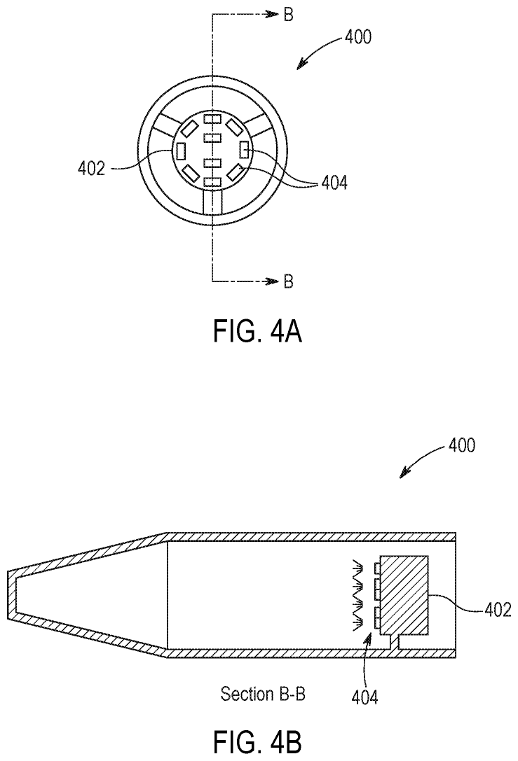

FIGS. 4A and 4B are cross-sectional views of another mock tailpipe 400 with a lighting source in accordance with embodiments. The tailpipe 400 of FIGS. 4A and 4B is substantially the same as the tailpipe 300 of FIGS. 3A and 3B except for the positioning of the light source. In this embodiment, tailpipe 400 includes an internal support member 402 coupled to the internal surface of the tailpipe 400 at three radial locations. The light source includes a number of LEDs 404, or other lighting elements, mounted to the inward facing side of the support member 402 to provide indirect illumination through the open side of the tailpipe 400. As in the embodiment shown on FIGS. 3A and 3B, the LEDs 404 may be activated simultaneously, or individual LEDs 404 or sets of LEDs 404 can be activated sequentially.

The mock tailpipes shown in FIGS. 3A, 3B, and 4A, and 4B may be included in a non-ICE vehicle or may be sold as after-market addition. Additionally, either of the tailpipe 300 and tailpipe 400 may also be fitted with additional components, such as sound source for generating backfire effects. For example, one or more speakers could be attached to or embedded within the support member 402 shown in FIGS. 4A and 4B. It will also be appreciated that each tailpipe 300 and tailpipe 400 will include circuitry for activating and driving the light source and/or sound generator, as well as circuitry for receiving data and/or instructions for the vehicle's electronic control unit.

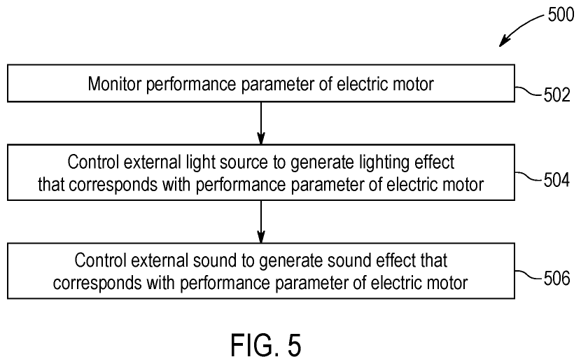

FIG. 5 is a process flow diagram summarizing an example method 500 of operating a lighting system for a non-ICE vehicle in accordance with embodiments. The method 500 may be performed by logic embodied in hardware, such as logic circuitry, one or more processors configured to execute instructions stored in a non-transitory, computer-readable medium, or combinations thereof. The method may begin at block 502.

At block 502, a performance parameter of an electric motor is monitored. The performance parameter may be any parameter related to performance of the vehicle, including driver inputs such as a torque demand setting, motor performance such as revolution rate, and vehicle movement such as vehicle speed or velocity.

At block 504, an external light source disposed outside of the non-ICE vehicle is controlled to generate a lighting effect that corresponds with the performance parameter of the electric motor. For example, if the performance parameter is a torque demand setting, controlling the external light source may include generating an illumination intensity that is proportional to the torque demand setting. As another example, if the performance parameter is a rate of vehicle acceleration or deceleration, controlling the external light source may include generating an illumination intensity that is proportional to the rate of vehicle acceleration or deceleration. As used herein, the phrase “disposed outside the vehicle” means the lighting effect is intended to be seen by people outside of the vehicle. It will be appreciated that a light source disposed outside the vehicle will include light sources disposed within a lighting assembly on the vehicle, such as light bar mounted to the back of the vehicle, lights mounted below the undercarriage of the vehicle, or lights disposed within a mock tailpipe, for example.

At block 506, an external sound generator is controlled to generate a sound effect that corresponds with the performance parameter of the electric motor. The sound effect may be generated in coordination with the controlling of the external light source to create a coordinated audio-visual effect, such as a vehicle backfire, or simulated transmission shift, for example.

The method 500 should not be interpreted as meaning that the blocks are necessarily performed in the order shown. Furthermore, fewer or greater actions can be included in the method 500 depending on the design considerations of a particular implementation.

While the invention may be susceptible to various modifications and alternative forms, specific embodiments have been shown by way of example. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A non-internal-combustion-engine (non-ICE) powered vehicle, comprising:
an electric motor for propelling the vehicle;
an external light source disposed on the outside of the vehicle; and
a controller to monitor a performance parameter of the electric motor and control the external light source to generate a lighting effect that corresponds with the performance parameter of the electric motor.

2. The non-ICE powered vehicle of claim 1, wherein the performance parameter is a torque demand setting and the external light source is controlled to generate an illumination intensity that is proportional to the torque demand setting.

3. The non-ICE powered vehicle of claim 1, wherein the performance parameter is a rate of vehicle acceleration or deceleration, and the external light source is controlled to generate an illumination intensity that is proportional to the rate of vehicle acceleration or deceleration.

4. The non-ICE powered vehicle of claim 1, comprising an external sound generator, wherein the external light source and the external sound generator are controlled by the controller to create a coordinated audio-visual effect.

5. The non-ICE powered vehicle of claim 4, wherein the coordinated audio-visual effect is to simulate a vehicle backfire.

6. The non-ICE powered vehicle of claim 1, wherein the external light source comprises a light bar disposed across a back of the vehicle.

7. The non-ICE powered vehicle of claim 1, wherein the external light source is disposed below an undercarriage of the vehicle.

8. The non-ICE powered vehicle of claim 1, comprising a tube disposed on the vehicle to simulate a vehicle exhaust pipe, wherein the external light source is disposed within the tube.

9. A method of operating a lighting system for a non-internal-combustion-engine (non-ICE) powered vehicle, comprising:
monitoring a performance parameter corresponding to input of a driver to an electric motor used for propulsion of the vehicle; and
controlling an external light source disposed outside of the vehicle to generate a lighting effect that corresponds with the performance parameter of the electric motor.

10. The method of claim 9, wherein the performance parameter is a torque demand setting and controlling the external light source comprises generating an illumination intensity that is proportional to the torque demand setting.

11. The method of claim 9, wherein the performance parameter is a rate of vehicle acceleration or deceleration, and controlling the external light source comprises to generating an illumination intensity that is proportional to the rate of vehicle acceleration or deceleration.

12. The method of claim 9, comprising controlling an external sound generator in coordination with the controlling of the external light source to create a coordinated audio-visual effect.

13. The method of claim 12, wherein the coordinated audio-visual effect simulates a vehicle backfire.

14. The method of claim 9, wherein the external light source comprises a light bar disposed across a back of the vehicle.

15. The method of claim 9, wherein the external light source is disposed below an undercarriage of the vehicle.

16. The method of claim 9, wherein the external light source is disposed within a tube disposed on the vehicle to simulate a vehicle exhaust pipe.

17. A lighting system for a non-internal-combustion-engine (non-ICE) powered vehicle, comprising:
a light source configured to generate an external lighting effect; and
a controller to monitor a performance parameter of an electric motor and control the light source to generate a lighting effect that corresponds with the performance parameter of the electric motor.

18. The lighting system of claim 17, wherein the performance parameter is a torque demand setting and controlling the light source comprises generating an illumination intensity that is proportional to the torque demand setting.

19. The lighting system of claim 17, wherein the performance parameter is a rate of vehicle acceleration or deceleration, and controlling the light source comprises generating an illumination intensity that is proportional to the rate of vehicle acceleration or deceleration.

20. The lighting system of claim 17, comprising a sound generator to generate an external sound effect, wherein the controller controls the sound generator in coordination with the controlling of the light source to create a coordinated audio-visual effect that simulates a vehicle backfire.
